(19) United States
(12) Patent Application Publication
(10) Pub. No.: US 2025/0254655 A1
(43) Pub. Date: Aug. 7, 2025

(54) A SYSTEM AND METHOD FOR ROUTING MANAGEMENT

(71) Applicant: RAKUTEN SYMPHONY, INC, Tokyo (JP)

(72) Inventor: Sridhar BHASKARAN, Bangalore, Karnataka (IN)

(73) Assignee: RAKUTEN SYMPHONY, INC, Tokyo (JP)

(21) Appl. No.: 18/699,965

(22) PCT Filed: Feb. 7, 2024
(86) PCT No.: PCT/US2024/014692

§ 371 Date: Apr. 10, 2024

(51) Int. Cl. H04W 68/02; H04L 45/741; H04W 76/27

(52) U.S. Cl. CPC H04W 68/02; H04L 45/741; H04W 76/27

(57) ABSTRACT

Embodiments of the present disclosure disclose a routing management system comprising a user plane control module, a session management module and a radio control module communicatively coupled with the user plane control module. The user plane control module is configured to receive a downlink data notification (DDN) of a User Equipment (UE) from a user plane system and determine whether the UE is in a Radio Resource Control (RRC)_INACTIVE state or an RRC_IDLE state in response to the DDN. The user plane control module is configured to initiate paging either through the radio control module if the UE is in the RRC_INACTIVE state or through the session management module if the UE is in the RRC_IDLE state. The user plane control module is configured to establish a communication between the UE and a Radio Access Network (RAN) node upon successful paging of the UE.

### TECHNICAL FIELD

The present disclosure generally relates to mobile communication technologies, and more specifically, to an architecture for a control plane function and a user plane function for routing management in low latency services.

### BACKGROUND

Mobile communication systems have been evolving every day and every second to provide efficient and reliable communication services to users. There are several types of communication services for mobile networks, including enhanced Mobile Broadband (eMBB), massive Machine Type Communication (mMTC) and Ultra-Reliable Low Latency Communication (uRLLC). User Equipment (UEs) may request a mobile network to provision one of the communication service types during registration of the UEs. Accordingly, if a UE registers for uRLLC services, the mobile network needs to provide communication services with extremely low latencies, such as less than 1 millisecond with high reliability. In addition, some UEs may also be associated with low mobility. For example, UEs such as Industrial Internet of Things (IIoT) devices, and home appliances may have limited mobility.

Further, such UEs may also be working in power saving mode like Discontinuous Transmission and/or Reception (DTX/DRX) mode, to save power when not in use. Such power saving modes may change a Radio Resource Control (RRC) state of the UEs from an RRC_CONNECTED to either RRC_INACTIVE state or RRC_IDLE state. UEs in RRC_INACTIVE state or RRC_IDLE state may be disconnected from the mobile network, thereby disabling the UEs to receive/transmit data from/to the mobile network. In such a scenario, routing data addressed to such UEs, during RRC_IDLE state or RRC_INACTIVE state, would require paging the UEs and then routing the data to the UEs upon successful paging. Paging the UEs involves communication between multiple core network entities such as a User Plane Function (UPF), a Session Management Function (SMF) and Radio Access Network (RAN) node entities such as RAN Central Unit-Control Plane (CU-CP) and RAN CU-User Plane (CU-UP).

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

In general, a combined user plane entity configured with functions of both the UPF and RAN CU-UP may communicate with an SMF and a RAN CU-CP to page a UE based on its RRC state. The combined user plane entity may communicate with the SMF to page a UE in RRC IDLE state and the RAN CU-CP to page a UE in RRC_INACTIVE state. Such communication requires the combined user plane entity to maintain two separate hardware modules and selectively route the communication based on the RRC states of the UEs. This results in hardware complexity at the combined user plane entity and unnecessary delay while communicating with various entities for different RRC states. Further, paging a UE with low mobility may not require such complex paging procedures, which need an involvement of core network entities and hence may be avoided since the location of the UEs are relatively known. The present disclosure provides a route management system and a user plane system to solve one or more problems mentioned above.

In an embodiment, present disclosure relates to a routing management system comprising a user plane control module, a session management module communicatively coupled with the user plane control module and a radio control module communicatively coupled with the user plane control module. The user plane control module is configured to receive a downlink data notification of a User Equipment (UE) from a user plane system and determine whether the User Equipment (UE) is in a Radio Resource Control (RRC)_INACTIVE state or an RRC_IDLE state based on the downlink data notification. The routing management system is further configured to perform one of initiating paging through the radio control module upon determining that the UE is in the RRC_INACTIVE state, and initiating paging through the session management module upon determining that the UE is in the RRC_IDLE state. The routing management system is further configured to establish a communication between the UE and a Radio Access Network (RAN) node upon successful paging of the UE.

In another embodiment, the present disclosure relates to a user plane system configured to receive downlink data, addressed to a User Equipment (UE), from a data network. The UE is in one of a Radio Resource Control (RRC)_INACTIVE state and an RRC_IDLE state. The user plane system is further configured to transmit a downlink data notification to the routing management system upon receiving the downlink data to initiate paging of the UE.

In yet another embodiment, the present disclosure relates to an access management system configured to receive a request from a User Equipment (UE) for registration and determine that the UE satisfies one or more predefined unification criteria. The access management system is configured to assign a session management module, communicatively coupled with a radio control module of a routing management system, to the UE based on the determination. The session management module is configured to assign a user plane system to the UE. The user plane system is configured to receive downlink data, addressed to the UE from a data network and route the downlink data to a serving Radio Access Network (RAN) node serving the UE. The routing management system is further configured to receive a downlink data notification for the UE from the user plane system, wherein the UE is in one of a Radio Resource Control (RRC)_INACTIVE state or an RRC_IDLE state. The routing management system is configured to perform paging of the UE upon receiving the downlink data notification and receiving UE data upon successful paging of the UE. The UE data comprises at least data associated with a RAN node where the UE is in RRC_CONNECTED state with the RAN node. The routing management system is further configured to generate packet detection rules for the UE comprising forwarding rules associated with at least packet data convergence protocol and service data application protocol without tunnelling rules and transmit the UE data and the packet detection rules to the user plane system for routing the downlink data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. The same numbers are used throughout the figures to reference features and components. Some embodiments of device and/or methods in accordance with embodiments of the present subject matter are now described, by way of example only, and with reference to the accompanying figures, in which:

FIG. 1a and FIG. 1b illustrate one or more components of an existing mobile network architecture, where some embodiments of the present disclosure may be practiced:

FIG. 2 illustrates an exemplary architecture for routing management in accordance with an embodiment of the present disclosure:

FIG. 3 illustrates an exemplary flow diagram representing an exemplary method of routing management in accordance with an embodiment of the present disclosure:

FIG. 4 illustrates an exemplary block diagram of a Routing Management System (RMS) for routing management, in accordance with an embodiment of the present disclosure:

FIG. 5 illustrates an exemplary block diagram of User Plane System (UPS) for routing management, in accordance with an embodiment of the present disclosure:

FIG. 6 illustrates an exemplary block diagram of Access Management System (AMS) for routing management, in accordance with an embodiment of the present disclosure:

FIG. 7 illustrates an exemplary flowchart of a method for routing management performed by the RMS in accordance with another embodiment of the present disclosure:

FIG. 8 illustrates an exemplary flowchart of a method for routing management performed by the UPS in accordance with another embodiment of the present disclosure: and

FIG. 9 illustrates an exemplary flowchart of a method for routing management performed by the AMS in accordance with another embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to methods and systems for achieving improved low latency services to UEs, especially to the UEs which are associated with low mobility. The present disclosure provides a routing management system comprising, SMF and RAN CU-CP, for determining a location of a UE when the UE is in one of RRC_INACTIVE or RRC_IDLE states. The routing management system pages the UE upon receiving a downlink data notification from a user plane system. The present disclosure also discloses various limitation of the user plane system for sending the downlink data notification to the routing management system of UEs in RRC_INACTIVE or RRC_IDLE states. Thus, the present disclosure eliminates the need for two different user plane functions (i.e UPF and RAN CU-UP) by combining them into a single user plane system and thus also eliminates sending two different downlink data notifications to two different entities such as SMF and RAN CU-CP. The present disclosure also discloses aspects related to a network interface between the user plane system and the routing management system to receive location of the UE upon successful paging from the routing management system. The user plane system may forward the downlink data directly to the RAN DU using one or more forwarding action rules, when the UE in RRC_CONNECTED state. The present disclosure also discloses aspects related to an access management system that assigns the routing management system comprising RAN CU-CP and SMF to the UEs that require low latency services and are associated with low mobility.

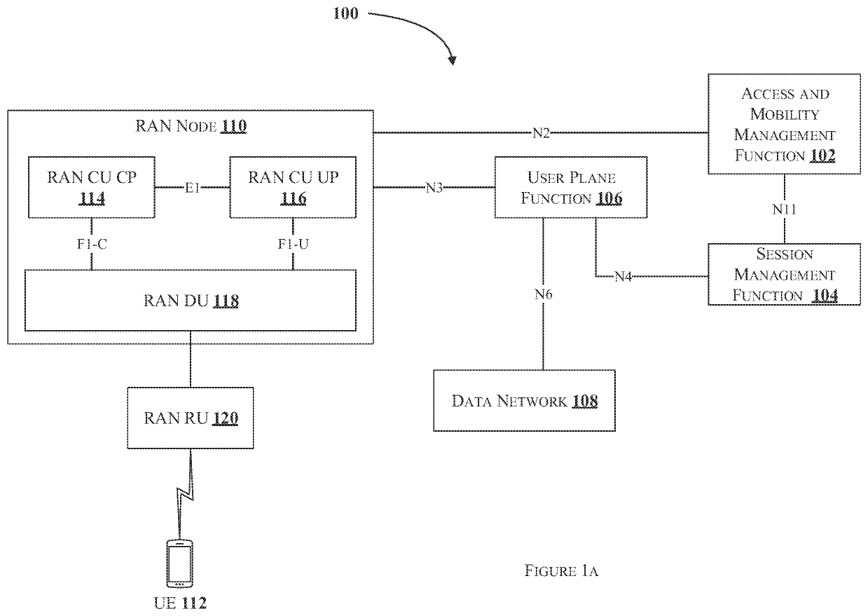

FIG. 1a illustrates one or more components of an existing mobile network architecture, where some embodiments of the present disclosure may be practiced.

As shown in FIG. 1a, the mobile network architecture 100 may comprise one or more components such as, but not limited to, an Access and Mobility management Function (AMF) 102, a Session Management Function (SMF) 104, a User Plane Function (UPF) 106, a Data Network (DN) 108, and a RAN node 110 providing communication services to a User Equipment (UE) 112. The one or more components of the mobile network architecture 100, hereinafter referred to as, the architecture 100, may correspond to a mobile network to provide the communication services. In some embodiments, the architecture 100 may be a 5^{th} Generation (5G) network architecture as specified by 3^{rd} Generation Partnership Project (3GPP) standard. Further, the RAN node 110 may be a disaggregated RAN node comprising at least a RAN Centralized Unit-Control Plane (CU-CP) 114, RAN CU-User Plane (CU-UP) 116, a RAN Distributed Unit (DU) 118 and a RAN Radio Unit (RU) 120. The one or more components 102-120 of the architecture 100 may perform one or more functions specified by the 3GPP standard and these functionalities are not explained herein for the sake of brevity. In addition to the one or more components depicted in FIG. 1a, the architecture 100 may also comprise one or more other components of 5G system architecture specified by the 3GPP standard.

Further, the components 102-110 and 114-118 may be communicating with one another via one or more interfaces as specified in 3GPP standard. Accordingly, the RAN node 110 may communicate with AMF 102 through an N2 interface and with the UPF 106 through an N3 interface. The UPF 106 may communicate with the SMF 104 through an N4 interface and with the DN 108 through an N6 interface. Further, the SMF 104 may communicate with the AMF 102 through an N11 interface. Furthermore, the RAN CU-CP 114 may communicate with the RAN CU-UP 116 through an E1 interface, the RAN DU 118 may communicate with the RAN CU-UP 116 through an F1-U interface, and with the RAN CU-CP 114 through an F1-C interface. The RAN DU 118 and RAN RU 120 may communicate with each other through an FH interface and the RAN RU 120 may communicate with the UE 112 through one or more physical interfaces such as one or more radio channels specified in 3GPP standards. Further, N1, N2, N4, N6, N11, E1, F1-U and F1-C interfaces mentioned above are standard interfaces to provide communication between corresponding components 102-118 for each interface as per the 3GPP standard.

The UE 112 may be any computing device configured to communicate with one or more components of the architecture 100 through the RAN RU 120. The UE 112 may be a mobile phone, a smartphone, a laptop, a notepad, electronic gadgets such as a smart watch etc., Internet of Things (IoT) based devices, and the like with 5G communication capabilities configured to communicate and/or access data from a data network through one or more components of the architecture 100. As such, in one example, the UE 112 may be configured to connect to the DN 108, through one or more components of the architecture 100. The DN 108 may provide various types of data such as, but not limited to, video data, audio data and/or any other data.

The DN 108 may be any type of third-party services communicating with the UPF 106 of the architecture 100 to provide services to one or more UEs, for e.g., the UE 112. For example, the DN 108 may be an Internet services Provider (ISP). For example, the DN 108 may be providing video data service, audio data service or other data available over the Internet.

In operation, the UE 112 may request the AMF 102 through the RAN node 110 to establish a Prtocol Data Unit (PDU) session for receiving one or more data from the DN 108. The request may include a plurality of parameters including at least a type of service required for the UE 112 such as, but not limited to, a uRLLC service. In response, the AMF 102 may select an SMF, such as, but not limited to, the SMF 104, based on a plurality of parameters including the type of service. Further, the AMF 102 may create a Session Management (SM) context for the PDU session in the SMF 104. The SMF 104 may be responsible for interacting with a UPF, for e.g., the UPF 106 to perform one or more of creating, updating, and removing PDU sessions and managing session context with the UPF, for e.g., the UPF 106.

The SMF 104 may further select the UPF 106, based on a plurality of parameters including, but not limited to, the requested data, a location of the UE 112, the type of service, an identifier of the DN 108. The SMF 104 may establish a user plane session context required for establishing the PDU session in the UPF 106. The user plane session context may include one or more Packet Detection Rules (PDRs), and Forward Action Rules (FAR), and Quality of Service (QOS) Enforcement Rules (QER) associated with the PDRs for the PDU session. Further, the UPF 106 may establish the PDU session for the UE 112 based on the request, receive the user plane session context from the SMF 104, and store the one or more rules to route downlink data in the PDU session. The UPF 106 may be responsible for receiving downlink data from the DN 108 and forward the downlink data based on the one or more rules through the PDU session. It may be appreciated that the user plane session context may comprise one or more rules to route uplink data from the UE 112 to the DN 108.

Upon initiating the PDU session, the UPF 106 may receive downlink data comprising a plurality of Internet Protocol (IP) packets from the DN 108. The UPF 106 may further route each IP packet within the PDU session in a General Packet Radio Service (GPRS) Tunnelling Protocol User Plane (GTPU) tunnel through the N3 interface to the RAN CU-UP 116. Further, the UPF 106 may add one or more headers such as, but not limited to, GTP-U header, a User Datagram Protocol (UDP) header, and an outer IP of GTP-U tunnel header. The UPF 106 may modify the received IP packet by adding one or more headers and may route the modified IP packet to the RAN CU-UP 116 through a GTP-U tunnel. The RAN CU-UP 116 may remove the one or more headers added by the UPF 106 and may further modify the IP packet by adding one or more other headers. Thereafter, the RAN CU-UP 116 may route the modified IP packet to the UE 112 through the RAN DU 118 and the RAN RU 120.

Thus, the routing of the IP packets through the GTP-U tunnel may facilitate mobility and bearer QoS enforcement within the GTP-U tunnel. Particularly, when the UE 112 is highly mobile between multiple RAN RUs 120, RAN DUS 118 and RAN CU-UPs 116, the UPF 106 may remain same while the GTP-U tunnel may be switched from a source RAN CU-UP to a target RAN CU-UP. However, for UEs that require low latency services such as, uRLLC services, and when the UEs are very less mobile or not mobile, the UPF 106 may be collocated at the RAN CU-UP 116 to avoid the GTP-U tunnelling on the N3 interface and thereby avoid adding the one or more headers associated with the GTP-U tunnelling. The architecture of the UPF 106 collocated at the RAN CU-UP 116 is explained further in FIG. 1b.

FIG. 1b illustrates one or more components of another existing mobile network architecture, where some embodiments of the present disclosure may be practiced.

As shown in FIG. 1b, the architecture 150 comprises a Combined User Plane Function (CUPF) 152 that combines the RAN CU-UP 116 and the UPF 106 located at the RAN node 110. In scenarios where the UE 112 satisfies one or more unification criteria, the SMF 104 may select the CUPF 152 to establish a PDU session between the UE 112 and the DN 108. The one or more unification criteria may include, but not limited to, low latency services and low mobility services. As shown in FIG. 1b, selecting the CUPF 152 may avoid tunneling between the RAN CU-UP 116 and UPF 106 on the N3 interface and hence reduce overhead to be included on the IP packet at the UPF 106. Further, the other components of the architecture 150 may interact with the CUPF 152 as with individual components RAN CU-UP 116 and the UPF 106, as described in the architecture 100.

A problem envisaged in the architecture 150 may be establishing PDU sessions with the UE 112 when the UE 112 is in one of RRC_INACTIVE state or RRC_IDLE state. When the CUPF 152 receives downlink data from the DN 108 and when the UE 112 is in one of RRC INACTIVE state or RRC_IDLE state, the CUPF 152 needs to initially locate the UE 112 in order to route the downlink data to the UE 112. However, the CUPF 152 may not have the details of the UE 112, such as, but not limited to, a RAN DU 118 associated with the UE 112 to communicate with the UE 112. Hence, the CUPF 152 may communicate with the RAN CU-CP 114 or SMF 104 to page the UE 112 and locate the UE 112. In an embodiment, the CUPF 152 may communicate with the RAN CU-CP 114 when the UE 112 is in RRC_INACTIVE state and the SMF 104 when the UE 112 is in RRC_IDLE state. Thus, even though the CUPF 152 has combined the UPF 106 and the RAN CU-UP 116 in a single entity, the CUPF 152 still requires two separate hardware modules to request two types of paging depending on the state of the UE (RRC_INACTIVE or RRC_IDLE). This increases hardware complexity at the CUPF 152.

Another problem envisaged in the architecture 150 may occur when the CUPF 152 is communicating with two control plane functions through two different interfaces at the same time. In other words, the CUPF 152 communicates with the SMF 104 through the N4 interface and with the RAN CU-CP 114 through the E1 interface. However, to remove the GTP-U tunneling and to enable the CUPF 152 to directly forward the downlink data received on N6interface to the RAN DU 118 through the F1-U interface, the SMF 104 needs to generate rules to remove the GTP-U tunneling and include Service Data Application Protocol (SDAP) and Packet Data Convergence Protocol (PDCP) configuration. However, the SDAP and the PDCP configuration data needs to be included in a communication happening through the E1 interface. Thus, sending data of the E1 interface through the N4 interface may lead to cross functional spillage between E1 interface and the N4 interface which may lead to unnecessary complexities.

Hence, there is a need for a system that reduces the complexity to track the RRC state of the UE 112 or avoids the requirement of tracking the RRC state of the UE 112.

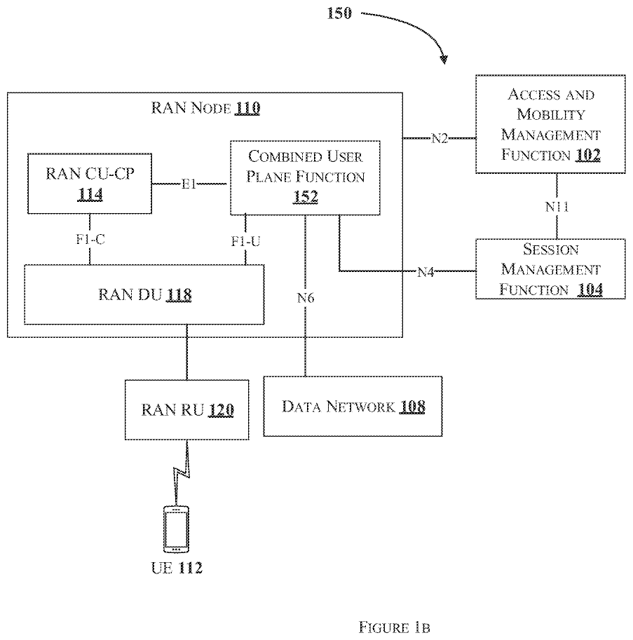

FIG. 2 illustrates an exemplary architecture for routing management in accordance with an embodiment of the present disclosure.

As shown in FIG. 2, the architecture 200 may comprise one or more components to route data between the DN 108 and the UE 112, when the UE 112 is associated with low latency and low mobility services. Accordingly, the present disclosure relates to providing a control plane architecture, herein after referred to as, a Routing Management System (RMS) 202, for collocating the SMF 104 at the RAN CU-CP 114 to provide efficient routing of data between the DN 108 and the UE 112. Further, the present disclosure relates to providing methods for communication between the RMS 202 and a CUPF, hereinafter referred to as, a User Plane System (UPS) 204 for the routing. The present disclosure also relates to providing an AMF, also referred to herein after as an Access Management System (AMS) 206, that communicates with the RMS 202. Furthermore, the present disclosure relates to providing a network interface, hereinafter referred to as NRC, to facilitate communication between the RMS 202 and the UPS 204.

The architecture 200 may comprise the RMS 202, the UPS 204 and the AMS 206 to efficiently route data between the DN 108 and the UE 112 through the RAN DU 118 and RAN RU 120. The RAN DU 118 may also be referred herein at some instances as “a RAN node” or “a serving RAN node” or “a current RAN node” indicating that the UE 112 is currently within a serving region of the RAN node 110. In some embodiments, the UPS 204 may be the CUPF 152 of FIG. 1b configured to perform one or more methods disclosed in the present disclosure. In some embodiments, the AMS 206 may be the AMF 102 of FIG. 1b configured to perform one or more methods disclosed in the present disclosure. Further, the RMS 202 may comprise a user plane control module 208, a session management module 210 and a radio control module 212.

The UPS 204 may communicate with the DN 108 over the N6 interface. The UPS 204 may communicate with the RMS 202 through the NRC interface. The NRC interface may be configured to communicate using one of Packet Flow Classification Protocol (PFCP) or E1 Application Protocol (E1AP). The UPS 204 may communicate with the RAN DU 118 through an NRD interface. The NRD interface may be one of a F1-U interface or User Datagram Protocol (UDP) tunnelling over Internet Protocol v6 (IPv6). In some embodiments, the UPS 204 may be installed proximate to the UE 112 to avoid any tunneling requirements to route the data of the UE 112 between the UE 112 and the DN 108. In some embodiments, the UPS 204 may be configured to provide one or more inline IP services such as, but not limited to, firewall, Network Address Translation (NAT), intrusion prevention systems, Hypertext Transfer Protocol (HTTP) header enrichment. The UPS 204 may also be configured to provide one or more usage records for a plurality of UEs to the RMS 202 separately for each UE 112.

The DN 108 of FIG. 2 may be configured to provide service function chaining (SFC) where each service is realized as a virtualized function in edge cloud.

Further, the session management module 210 of the RMS 202 may perform one or more functions of the SMF 104 of the FIGS. 1a and 1b. The radio control module 212 may perform one or more functions of the RAN CU-CP 114 of the FIGS. 1a and 1b. The session management module 210 and the radio control module 212 may be implemented as one of hardware, software, or firmware modules. Further, the session management module 210 and the radio control module 212 may also be implemented as one of virtual machines, or cloud functions. The session management module 210 may communicate with the AMS 206 through the N11 interface. The radio control module 212 may communicate with the AMS 206 through the N2 interface and with the RAN DU 118 through the F1-C interface. The session management module 210 may be configured to generate one or more charging records towards a charging function for the UE 112. The session management module 210 may also be configured to selectively switch off the charging function when there is a need.

Further, the user plane control module 208 may create a UE context for the UE 112 in a memory of the RMS 202 upon receiving the UE context from the AMS 206. In some embodiments, the UE context may be set up by the AMS 206 in response to a “UE request for initial context setup”. In these embodiments, the AMS 206 may be an AMF where the UE 112 is anchored. The UE context may be classified as a core-level UE context information indicating a Session Management (SM) state of one or more PDU sessions and a RAN-level UE context information indicating the RRC state of the UE 112. The core-level UE context information may comprise, but not limited to active PDU session context including a PDU session address, PDU session authorization information, PDU session policy context of each of the one or more PDU sessions. In one example, the PDU session address may be IPV4/IPv6/Ethernet address. The RAN-level UE context information may be one of RRC_CONNECTED, RRC_INACTIVE or RRC_IDLE states. For example, the RAN-level UE context information may include a temporary UE identifier such as S-Temporary Mobile Subscriber Identity (S-TMSI) and the core-level UE context information may include a permanent identifier such as International Mobile Subscriber Identity (IMSI) of the UE 112. In some embodiments, the user plane control module 208 may regularly update the UE context based on an activity of the UE 112. For example, when the UE is inactive, the user plane control module 208 may update the UE context as RRC_INACTIVE or RRC_IDLE states.

Thus, the architecture 200 provides the UE context, comprising both the RAN-level and core-level UE context, at the RMS 202 where the existing architectures such as the architecture 100 and 150 only enable storing the core-level UE context only at the SMF 104. The UE context may provide visibility of the core-level UE context data, for e.g., IMSI, to the radio control module 212, which may not be facilitated to the RAN CU-CP 114 of the existing architectures 100 and 150 of FIGS. 1a and 1b.

In some embodiments, the user plane control module 208 may send the UE to the session management module 210 and the radio control module 212. In one embodiment, the session management module 210 may send the UE context to the radio control module 212.

The user plane control module 208 may be configured to establish a user plane session context for a PDU session of the UE 112 in the UPS 204. The user plane session context includes one or more packet detection rules, one or more forwarding rules and one or more QoS enforcement rules. The one or more packet detection rules include, but not limited to, receiving downlink data from the DN 108 and classifying downlink data addressed to the UE 112. The one or more packet detection rules may be associated with one or more forwarding rules for forwarding and/or taking action on the downlink data addressed to the UE 112 to the RAN DU 118 when there is an associated forwarding rule. In some embodiments, the forwarding rules may be similar to forwarding action rules defined in 3GPP standards. In other case, when the downlink data is not associated with any existing forwarding rule, one or more packet detection rules may include one or more Buffer Action Rules (BARs) for buffering the downlink data at the UPS 204 until the UPS 204 receives a current location of the UE 112 from the RMS 208. In addition, the one or more packet detection rules may also include one or more rules for sending a downlink data notification to the RMS 202 when the downlink data is not associated with any existing forwarding rule. The user plane session context may also indicate that the UE 112 has subscribed for low latency services and is moving with less mobility, such as, but not limited to, within the RAN RU 120 or within the RAN DU 118.

Further, the user plane control module 208 may receive a Downlink Data Notification (DDN) of the UE 112 from the UPS 204, through the NRC interface, based on the user plane session context. The DDN may comprise, but not limited to, an identifier of the UE 112 session context for the NRC interface and an identifier of the DN 108. The DDN may indicate that downlink data addressed to the UE 112 has arrived from the DN 108 and there is no associated forwarding rule to forward the downlink data.

The user plane control module 208 may determine whether the UE 112 is in one of RRC_INACTIVE state and an RRC_IDLE state based on the identifier included in the downlink data notification and the UE context of the UE 112. The user plane control module 208 may initiate paging of the UE 112 through the radio control module 212 upon determining that the UE 112 is in RRC_INACTIVE state. On the other hand, when the UE 112 is in RRC_IDLE state, the user plane control module 208 may initiate paging through the session management module 210.

In some embodiments, the paging initiated through the radio control module 212 may be equivalent to RAN-initiated paging as disclosed in, but not limited to, TS 38.401 of the 3GPP standards. The radio control module 212 may initiate RAN paging by communicating with the RAN DU 118 through the F1-C interface. The RAN DU 118 may page the UE 112 in one or more RAN RUs communicatively coupled with the RAN DU 118. In some embodiments, the RAN RU 120 is assumed as a current RAN RU of the UE 112. When the RAN RU 120 pages the UE 112 within its serving area, the UE 112 may transmit an RRC-Resume request, in response to the paging. The RRC-Resume request may indicate that the UE 112 has moved to the serving region of the RAN RU 120 and is requesting to receive data through the RAN RU 120. The RAN DU 118 may receive the RRC-Resume request from the UE 112 from the RAN RU 120 and forward it to the radio control module 212 which may assign a radio bearer to the UE 112. Further, the radio control module 212 may change the RRC state of the UE 112 to RRC_CONNECTED state.

In some embodiments, the paging initiated through the session management module 210 may be equivalent to Core Network (CN)-initiated paging when the UE 112 is in RRC_IDLE state. The session management module 210 may send a request to the AMS 206 that the UE 112 needs to be paged. The AMS 206 may be referred to as an AMF where the UE 112 was anchored. The AMS 206 may retrieve a list of RAN Tracking Areas (RTAs) that are stored in the AMS 206. The AMS 206 may further page the UE 112 in the plurality of RTAs stored in the AMS 206. In some embodiments, the UE 112 may be located within a serving region of the RAN RU 120 communicatively coupled with the RAN DU 118. In other embodiments, the UE 112 may be located within a serving region of any other RAN RU or RAN DU whose RTA is listed in the AMS 206.

Further, the UE 112 transmits an RRC-Setup request to the RAN RU 120 and further to the RAN DU 118 in response to the paging. Further, the AMS 206 may send current information of the UE 112 that includes, but not limited to, current RAN DU 118 to the session management module 210 through the N11 interface.

Upon successful paging of the UE 112, one of the radio control module and the session management module 210 may send UE data and the associated RAN DU 118 to the user plane control module 208. The UE data may comprise a location of the UE 112, a current RAN RU, such as, but not limited to the RAN RU 120, where the UE 112 is connected in RRC_CONNECTED state. Further, the user plane control module 208 may update the RRC state of the UE context of the UE 112 as RRC_CONNECTED state. Thereafter, the user plane control module 208 may send the UE data to the UPS 204 through the N_{RC} interface. The user plane control module 208 may also generate one or more forwarding rules for the downlink data to be included in the user plane session context. The one or more forwarding rules may be associated with the PDCP configuration and the SDAP configuration. The UPS 204 may further route the downlink data that was previously buffered and stored in the UPS 204 to the UE 112 based on the UE data to the current RAN DU 118 through F1-U interface or User Datagram Protocol (UDP) tunnelling over Internet Protocol v6 (IPv6).

The UPS 204 may receive a user plane session context for a PDU session of the UE 112 from the RMS 202. The user plane session context includes one or more packet detection rules, one or more forwarding rules, one or more buffer action rules and one or more QoS enforcement rules. The one or more packet detection rules include, but not limited to, receiving downlink data from the DN 108, and classifying downlink data addressed to the UE 112. The one or more buffer action rules include, but not limited to, buffering the downlink data at the UPS 204 until the RMS 202 sends a location of the UE 112. The one or more packet detection rules also include sending a downlink data notification to the RMS 202. The forwarding rules may be associated with a PDCP configuration and a SDAP configuration. The user plane session context may also indicate that the UE 112 has subscribed for low latency services and is moving with less mobility, such as, but not limited to, within the RAN RU 120 or within the RAN DU 118.

Upon receiving the user plane session context, the UPS 204 may store the one or more packet detection rules and associated forwarding rules within the UPS 204. Further, the UPS 204 may apply the one or more packet detection rules and forwarding rules on any downlink data addressed to the UE 112.

In one embodiment, when the UPS 204 receives downlink data from the DN 108, the UPS 204 may classify the downlink data as the downlink data addressed to the UE 112 based on an identifier of the UE 112 indicated in the downlink data. Further, the UPS 204 may determine that the one or more packet detection rules and the forwarding rules may be applied to the downlink data. Further, based on the one or more packet detection rules, the UPS 204 may determine that the downlink data is associated with the UE 112 and that the downlink data is not associated with any forwarding rule. Further, the UPS 204 may initiate buffering of the downlink data as there is no GTP-U tunnel for the UE 112 to forward the downlink data. Thereafter, the UPS 204 may generate the DDN indicating that the downlink data addressed to the UE 112 has arrived from the DN 108. The UPS 204 may send the DDN to the RMS 202 to receive a location of the UE 112 and corresponding RAN-DU.

Thereafter, the UPS 204 may receive UE data comprising, but not limited to, a location of the UE 112, a current RAN DU, such as, but not limited to the RAN DU 118, where the UE 112 is connected in RRC_CONNECTED state. Further, the UPS 204 may forward the previously buffered downlink data, and current data received from the DN 108, to the UE 112 based on the forwarding rules as per the PDCP and/or SDAP rules. The UPS 204 may forward the downlink data through the NRD interface which may be one of F1-U interface or UDP tunnelling over IPv6.

Furthermore, the AMS 206 may receive a request from the UE 112 for a registration such as, but not limited to, to allocating a radio channel for communication with the DN 108. The AMS 206 may determine if the UE 112 satisfies one or more predefined unification criteria. The one or more predefined unification criteria may include that UE 112 is requesting for one of low latency services and low mobility services. For example, a UE 112 such as, an IIoT device or a home appliance may require low latency and low mobility services to operate remotely. Further, the AMS 206 may assign the session management module 210 that is collocated with the radio control module 212, such as, but not limited to, the RMS 202, for establishing a PDU session for the UE 112. Further, the RMS 202 may assign the UPS 204 that is configured to receive the downlink data addressed to the UE 112, that may be in either RRC_INACTIVE or RRC_IDLE states and may send a DDN to the RMS 202.

In other words, upon receiving downlink data from the DN 108, the UPS 104 may determine if there are one or more forwarding rules for forwarding the downlink data to the UE 112. Upon determining an absence of any forwarding rule or upon determining that there is a Buffer Action Rule (BAR) to buffer the downlink data for the UE 112, the UPS 204 may buffer the downlink data. Further, the UPS 204 may generate the DDN and may send the DDN to the CPS 202.

In an example, the DN 108 may be an industry server, that requires sending actuation data, such as, one or more instructions, to a UE 112 such as an IIoT device 112. In operation, the industry server 108 may send the actuation data to the UPS 204 where the IIoT device 112 is anchored. The IIoT device 112 may be in data inactive mode which may release its RRC state from RRC_CONNECTED state to RRC_INACTIVE state or RRC_IDLE state. In response, the UPS 204 may receive a user plane session context from the RMS 202 including packet detection rules without an associated forwarding rule for data addressed to the IIoT device. The packet detection rules may configure the UPS 206 to send a DDN to the RMS 202 upon receiving any downlink data from the DN 108 to the IIoT device. When the UPS 204 receives the actuation data, the UPS 204 may buffer the actuation data based on the user plane session context. The UPS 204 further sends a DDN through the NRC interface to the RMS 202, indicating the arrival of the actuation data to the IIoT device 112. The RMS 202 performs paging through the radio control module 212 if the IIoT device 112 is in RRC INAVTIVE state or through the session management module 210 if the IIoT device 112 is in RRC_IDLE state. Upon successful paging of the IIoT device 112, the RMS 202 sends the UE data indicating a location of the IIoT device 112 and the corresponding RAN DU 118 to the UPS 204. The UPS 204 forwards the actuation data to the RAN DU 118, which may further transmit the actuation data to the RAN RU 120. The example described here shall not be construed in a limiting sense.

Thus, the architecture 200 provides efficient and reliable low latency services to the UE 112 by collocating the SMF 104 and the RAN CU-CP 114 in the RMS 202 closer to the UE 112. Especially, when the UE 112 is associated with less mobility, such an architecture 200 may facilitate providing faster communication services to the UE 112. Furthermore, the UPS 204 interacts with only one entity such as the RMS 202 for two types of paging of the UE 112, instead of performing two types of paging through two different entities, that is, the SMF 104 and the RAN CU-CP 114. Thus, the architecture 200 reduces hardware complexity at the UPS 204, for example, by eliminating the need to track the RRC state of the UE 112 and the need to maintain two different hardware modules to communicate with the two entities based on the RRC state. Furthermore, UEs that do not require mobility across large areas may have an IP address of the UE 112 anchored at the UPS 152 and avoid any tunnelling function.

Further, the architecture 200 provides methods and systems to directly bind the downlink data addressed to the UE 112 to one or more RAN radio bearer by routing the downlink data to the RAN DU 118 without tunnelling the downlink data through the GTP-U tunnels. Hence, such a direct binding of the downlink data through the radio bearers from the UPS 204 may facilitate to use service function chaining using IP headers themselves in mid-haul.

Further, the architecture 200 also provides a single interface NRC to interact with the RMS 202. This helps to address the problem of cross-functional spillage that occurs when the UPS 204 interacts with SMF 104 and RAN CU-CP 114 separately. Also, the architecture 200 does not require use of native IP routers architecture thereby removing the need for special 3GPP GTP-U tunnelling devices and reducing the cost of the 3GPP architecture. As the downlink data arriving from the DN 108 is directly forwarded to the RAN DU 118 without adding any overhead required for GTP-U tunnelling, the architecture 200 reduces the overhead required for the GTP-U tunnelling while forwarding the downlink data.

In another embodiment, the AMS 206, may determine that the UE 112 is anchored in a UPS 204 configured to perform one or more functions of the UPF 106 and the RAN CU-UP 116. The AMS 206 may further determine from the UE context that the UE 112 is in RRC_IDLE state and associated with low mobility and requires low latency services. Based on the UE context, the AMS 206 may change the RRC state of the UE 112 from RRC_IDLE to RRC_INACTIVE state.

Thus, the AMS 206 may perform paging for a UE 112, in RRC_IDLE state, at RAN level using the radio control module 212 as the core network-initiated paging may not be required for a UE with low mobility. Thus, the AMS 206 may reduce processing resources and core network resources required to perform a core network-initiated paging for such UEs by avoiding performing core network-initiated paging for UE in RRC_IDLE state.

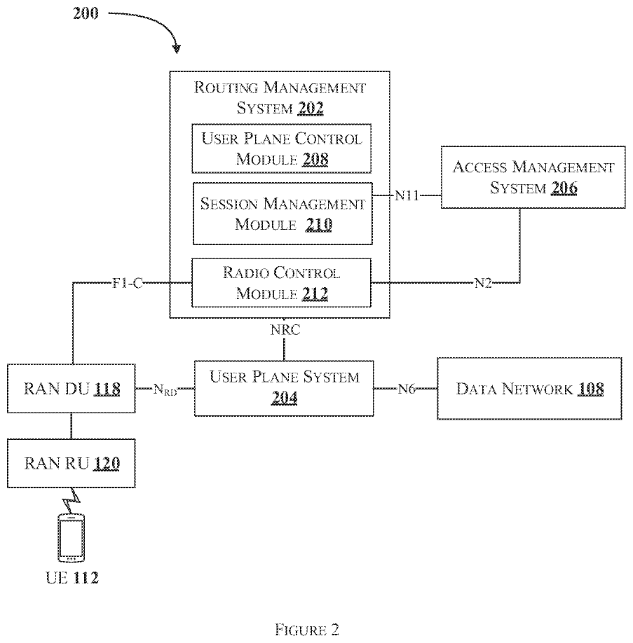

FIG. 3 illustrates an exemplary flow diagram representing a method for routing management in accordance with an embodiment of the present disclosure.

At step 302, the AMS 206 may receive a registration request from the UE 112 to receive one or more of low latency services and low mobility services.

At step 304, the AMS 206 may generate UE context for the UE 112 based on the registration request. The information of the UE 112 may comprise a location, an SM context and an RRC context of the UE 112. The AMS 206 also determines that the UE 112 satisfies one or more unification criteria of low latency services and low mobility services.

At step 306, the AMS 206 may assign the RMS 202 for the UE 112, where the session management module 210 is collocated with a radio control module 212 to establish a PDU session for the UE 112 and send the UE context to the RMS 202.

At step 308, the RMS 202 may receive the UE context and may establish PDU session for the UE 112. Further, the RMS 202 may also determine that downlink data to the UE 112 may be provided using a UPS 204 that performs functionalities of the UPF 106 and RAN UC-CP 116. Further, the RMS 202 may regularly update the UE context by communicating with the AMS 206 and the RAN DU 118. The RMS 202 may determine if the UE 112 has changed its RRC state from RRC_CONNECTED state to RRC_INACTIVE state or RRC_IDLE state and accordingly updates the UE context.

At step 310, the RMS 202 may generate a user plane session context comprising one or more packet detection rules to receive downlink data from the DN 108, classify downlink data addressed to the UE 112, buffer the downlink data when the downlink data is not associated with any forwarding rule, and send a DDN to the RMS 202 through the N_{RC} interface. Further, the RMS 202 may send the user plane session context to the UPS 204 through the N_{RC} interface.

At step 312, the UPS 204 may receive the user plane session context from the RMS 202 and may store the one or more packet detection rules and forwarding rules in the UPS 204.

At step 314, the DN 108 transmits the downlink data from the UPS 204. The UPS 204 may determine that the downlink data is addressed to the UE 112, determine there is no associated forwarding rule, buffer the downlink data, and may send a DDN to the RMS 202 through the N_{RC} interface at step 316, if the UPS does not have an associated forwarding rule.

At step 316, the RMS 202 may receive the DDN for the UE 112 from the UPS 204 indicating arrival of downlink data to the UE 112. The RMS 202 may determine the UE context of the UE 112 as one of RRC_INACTIVE or RRC_IDLE states. Further, the RMS 202 may perform paging of the UE 112 through the radio control module 212 when the UE 112 is in RRC_INACTIVE state and through the session management module 210 when the UE 112 is in RRC_IDLE state.

At 318, upon successful paging of the UE 112, the RMS 202 may establish a communication between the UE 112 and the RAN DU 118 and may send a location of the UE 112 and the RAN DU 118 where the UE 112 is currently located to the UPS 204 through the NRC interface.

At 320, the UPS 204 forwards the buffered downlink data and current downlink data to the UE 112 based on the location of the UE 112 through the RAN DU 118 via one of F1-C interface or UDP over IPv6.

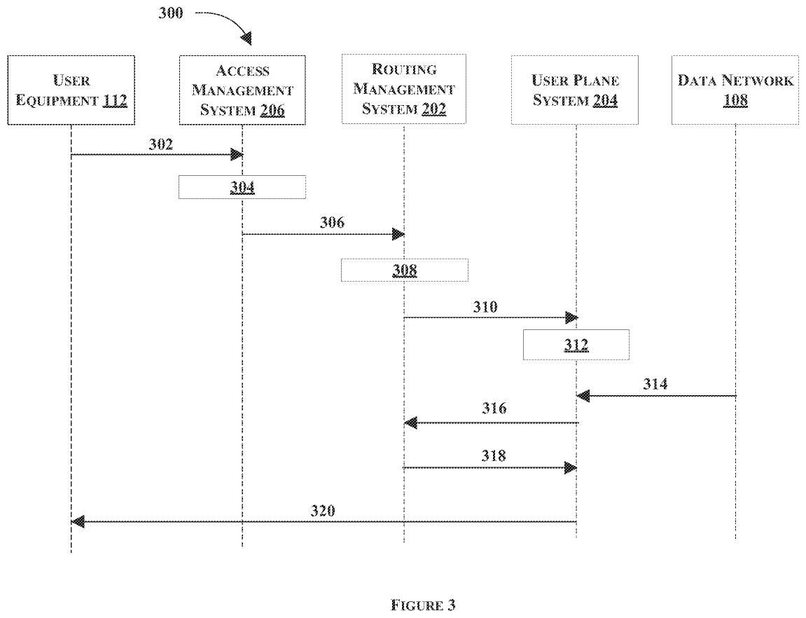

FIGS. 4-6 illustrate exemplary block diagrams of one or more systems described in the present disclosure.

FIG. 4 illustrates an exemplary block diagram of the RMS 202 for routing management, in accordance with an embodiment of the present disclosure.

The RMS 202 includes at least one processor 402 communicably coupled to the session management module 210, radio control module 212, an Input/Output (I/O) interface 404, a communication interface 406 and a memory 408. The components of the RMS 202 provided herein are not exhaustive, and that the RMS 202 may include more or fewer components than that of depicted in FIG. 4. Further, two or more components may be embodied in one single component, and/or one component may be configured using multiple sub-components to achieve the desired functionalities. Some components of the RMS 202 may be configured using hardware elements, software elements, firmware elements and/or a combination thereof. Further, the RMS 202 is communicatively coupled with the UPS 204, the AMS 206, and the RAN DU 118. As the RMS 202 comprises the session management module 210 equivalent to the SMF 104 and radio control module 212 equivalent to the RAN CU-CP 114, the RMS 202 may be communicatively coupled with one or more other components that are communicating with the SMF 104 and the RAN CU-CP 114 of 5G communication architecture as disclosed in the 3GPP standards.

In one embodiment, the processor 402 may be embodied as a multi-core processor, a single core processor, or a combination of one or more multi-core processors and one or more single core processors. For example, the processor 402 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like. In some embodiments, the user plane control module 208 may be the processor 402.

The I/O interface 404 may include mechanisms configured to receive inputs from and provide outputs to peripheral devices. For instance, the I/O interface 404 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a User Interface (UI) display (such as a light emitting diode display, a thin-film transistor (TFT) display, a liquid crystal display, an active-matrix organic light-emitting diode (AMOLED) display, etc.), a speaker, a ringer, a vibrator, and the like.

In one embodiment, the communication interface 406 includes a transceiver for wirelessly communicating information to, or receiving information from, the UPS 204, the AMS 206, and the RAN DU 118 and one or more other network elements of the 5G communication architecture. The communication may be achieved over a communication network. The communication interface 406 may be dependent on the network function with which the RMS 202 communicates with. For example, the communication interface 406 may be NRC interface when communicating with the UPS 204, N11 or N2 interface when communicating with the AMS 206 and F1-C interface when communicating with the RAN DU 118.

The memory 408 can be any type of storage accessible to the processor 402. For example, the memory 408 may include volatile or non-volatile memories, or a combination thereof. In an embodiment, the memory 408 stores a plurality of UE context associated with a plurality of UEs 112 anchored with the RMS 202. The memory 408 may also include instructions 410 to perform one or more methods of the RMS 202 as described in the present disclosure. In f embodiments, the instructions 410 may cause the processor 402 to perform one or more methods of the RMS 202.

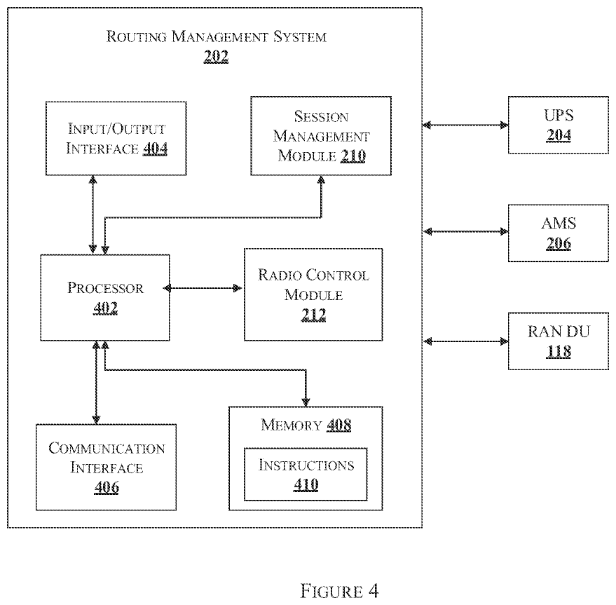

FIG. 5 illustrates an exemplary block diagram of the UPS 204 for routing management, in accordance with an embodiment of the present disclosure.

The UPS 204 includes at least one processor 502 communicably coupled to, an Input/Output (I/O) interface 504, a communication interface 506 and a memory 508. The components of the UPS 204 provided herein are not exhaustive, and that the UPS 204 may include more or fewer components than that of depicted in FIG. 5. Further, two or more components may be embodied in one single component, and/or one component may be configured using multiple sub-components to achieve the desired functionalities. Some components of the UPS 204 may be configured using hardware elements, software elements, firmware elements and/or a combination thereof. Further, the UPS 204 is communicatively coupled with the RMS 202, and the RAN DU 118.

In one embodiment, the processor 502 may be embodied as a multi-core processor, a single core processor, or a combination of one or more multi-core processors and one or more single core processors. For example, the processor 502 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

The I/O interface 504 may include mechanisms configured to receive inputs from and provide outputs to peripheral devices. For instance, the I/O interface 504 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

In one embodiment, the communication interface 506 includes a transceiver for wirelessly communicating information to, or receiving information from, the RMS 202, and the RAN DU 118 and one or more other network elements of the 5G communication architecture. The communication may be achieved over a communication network. The communication interface 506 may be dependent on the network function with which the UPS 204 communicates with. For example, the communication interface 506 may be NRC interface when communicating with the RMS 202, and F1-U or UDP over IPv6 interface when communicating with the RAN DU 118.

The memory 508 can be any type of storage accessible to the processor 502. For example, the memory 508 may include volatile or non-volatile memories, or a combination thereof. In an embodiment, the memory 508 stores the one or more packet detection rules and forwarding rules and buffered downlink data. The memory 508 may also include instructions 510 to perform one or more methods of the UPS 204 as described in the present disclosure. In some embodiments, the instructions 510 may cause the processor 502 to perform one or more methods of the UPS 204.

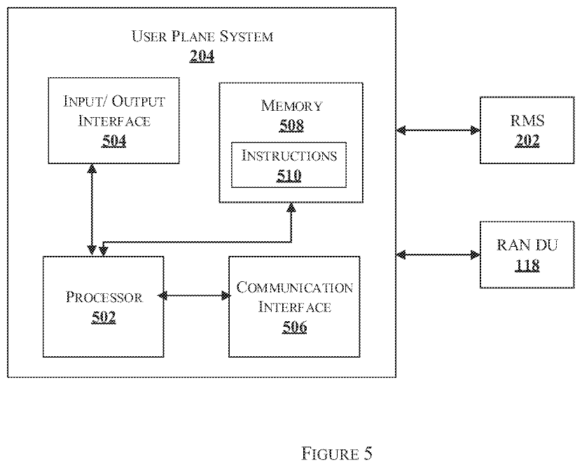

FIG. 6 illustrates an exemplary block diagram of the AMS 206 for routing management, in accordance with an embodiment of the present disclosure.

The AMS 206 includes at least one processor 602 communicably coupled to, an Input/Output (I/O) interface 604, a communication interface 606 and a memory 608. The components of the AMS 206 provided herein are not exhaustive, and that the AMS 206 may include more or fewer components than that of depicted in FIG. 6. Further, two or more components may be embodied in one single component, and/or one component may be configured using multiple sub-components to achieve the desired functionalities. Some components of the AMS 206 may be configured using hardware elements, software elements, firmware elements and/or a combination thereof. Further, the AMS 206 is communicatively coupled with the RMS 202.

In one embodiment, the processor 602 may be embodied as a multi-core processor, a single core processor, or a combination of one or more multi-core processors and one or more single core processors. For example, the processor 602 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

The I/O interface 604 may include mechanisms configured to receive inputs from and provide outputs to peripheral devices. For instance, the I/O interface 604 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

In one embodiment, the communication interface 606 includes a transceiver for wirelessly communicating information to, or receiving information from, the RMS 202, and one or more other network elements of the 5G system architecture. The communication may be achieved over a communication network. The communication interface 606 may be dependent on the network function with which the AMS 206 communicates with. For example, the communication interface 606 may be N11 or N2 interface when communicating with the RMS 202.

The memory 608 can be any type of storage accessible to the processor 602. For example, the memory 608 may include volatile or non-volatile memories, or a combination thereof. In an embodiment, the memory 608 stores the one or more packet detection rules and forwarding rules and buffered downlink data. The memory 608 may also include instructions 610 to perform one or more methods of the AMS 206 as described in the present disclosure. In some embodiments, the instructions 610 may cause the processor 602 to perform one or more methods of the AMS 206.

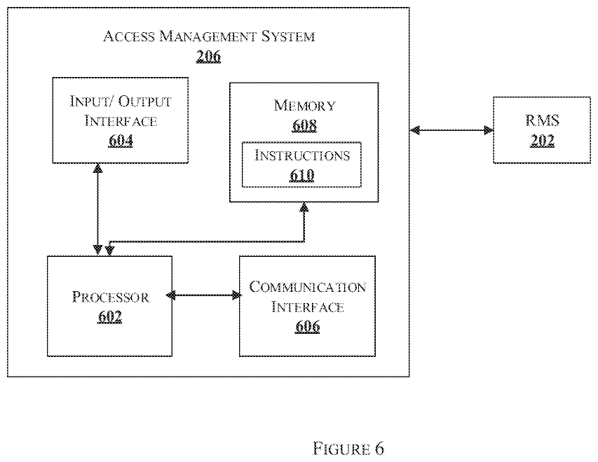

FIG. 7 illustrates an exemplary flowchart of a method for routing management performed by the RMS 202 in accordance with another embodiment of the present disclosure.

The method 700 may be described in the general context of computer executable instructions. Generally, computer executable instructions can include routines, programs, objects, components, data structures, procedures, modules, and functions, which perform specific functions or implement specific abstract data types. The order in which the method 700 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 702, the RMS 202 may receive a DDN of a UE 112 from the UPS 204, wherein the DDN indicates that the downlink data addressed to the UE 112 has arrived at the UPS 204.

At block 704, the RMS 202 may determine whether the UE is in RRC_INACTIVE state or RRC_IDLE state.

At block 706, the RMS 202 may initiate paging through the radio control module 212 upon determining that the UE is in RRC_INACTIVE state along the “YES” path from block 704.

Alternatively, at block 708, the RMS 202 initiates paging through the session management module 210 upon determining that the UE is in RRC_IDLE state along the “NO” path from block 704.

At block 710, the RMS 202 may establish a communication between the UE and a RAN node such as the RAN DU 118 upon successful paging of the UE 112 and determining that the UE 112 is located currently at the RAN DU 118.

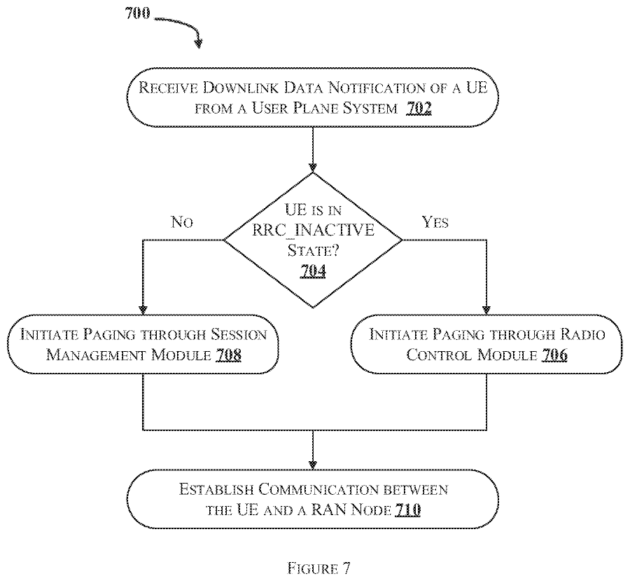

FIG. 8 illustrates an exemplary flowchart of a method for routing management performed by the UPS 204 in accordance with another embodiment of the present disclosure.

The method 800 may be described in the general context of computer executable instructions. Generally, computer executable instructions can include routines, programs, objects, components, data structures, procedures, modules, and functions, which perform specific functions or implement specific abstract data types. The order in which the method 800 is described is not intended to be construed as a limitation, and any number of the method blocks described can be combined in any order to implement the method. Additionally, individual blocks may be deleted from the methods without departing from the scope of the subject matter described herein. Furthermore, the method can be implemented in any suitable hardware, software, firmware, or combination thereof.

At block 802, the UPS 204 may receive downlink data addressed to the UE 112, from the DN 108. The UE 112 is in one of a Radio Resource Control (RRC)_INACTIVE state and an RRC_IDLE state.

At block 804, the UPS 204 may transmit a DDN to the RMS 202 upon determining that the downlink data is not associated with any forwarding rule. The UPS 204 may determine that the UE 112 is either in RRC_INACTIVE or RRC_IDLE state as there is no associated forwarding rule. Further, the UPS 204 may generate a DDN indicating arrival of the downlink data to initiate paging of the UE 112, and transmit the DDN to the RMS 202.—else the UPS forwards the packet to RAN DU.

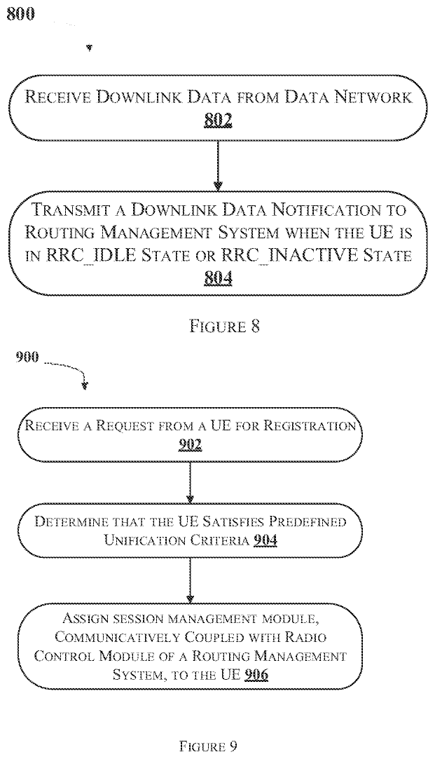

FIG. 9 illustrates an exemplary flowchart of a method for routing management performed by the AMS 206 in accordance with another embodiment of the present disclosure.

The method 900 may be described in the general context of computer executable instructions. Generally, computer executable instructions can include routines, programs, objects, components, data structures, procedures, modules, and functions, which perform specific functions or implement specific abstract data types. The order in which the method 900 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 902, the AMS 206 may receive a request from the UE 112 for registration with the AMS 206.

At block 904, the AMS 206 may determine that the UE 112 satisfies predefined unification criteria.

At block 906, the AMS 206 may assign session management module 210 communicatively coupled with radio control module 212 of the RMS 202 to the UE 112 upon determining that the UE 112 satisfied the predefined unification criteria.

The methods disclosed with reference to FIGS. 7-9, or one or more operations of the RMS 202, UPS 204 and the AMS 206 explained with reference to FIGS. 2-6 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

[Clause 1] In an aspect, a routing management system is disclosed. The routing management system comprises a user plane control module, a session management module communicatively coupled with the user plane control module and a radio control module communicatively coupled with the user plane control module. The user plane control module is configured to receive a downlink data notification of a User Equipment (UE) from a user plane system and determine whether the User Equipment (UE) is in a Radio Resource Control (RRC)_INACTIVE state or an RRC_IDLE state in response to the downlink data notification. The user plane control module is configured to perform one of initiating paging through the radio control module upon determining that the UE is in the RRC_INACTIVE state and initiating paging through the session management module upon determining that the UE is in the RRC_IDLE state. The user plane control module is configured to establish a communication between the UE and a Radio Access Network (RAN) node upon successful paging of the UE.

[Clause 2] In an aspect, the user plane control module, of the clause 1, is configured to determine whether the User Equipment (UE) is in a Radio Resource Control (RRC)_INACTIVE state or an RRC_IDLE state based on a core-level UE context information and a RAN-level UE context information.

[Clause 3] In an aspect, the session management module, of the clause 1, is configured to initiate the paging by transmitting a paging initiation request to an access management system located in a core network.

[Clause 4] In an aspect, the radio control module, of the clause 1, is configured to initiate the paging by transmitting a paging initiation request to a serving RAN node.

[Clause 5] In an aspect, the user plane control module, of the clause 1, is further configured to establish a user plane session context in the user plane system, wherein the user plane session context comprising one or more packet detection rules and one or more forwarding rules. The packet detection rules comprising receiving downlink data from a data network addressed to the UE and sending a downlink data notification to the routing management system. The one or more forwarding rules associated with at least one of PDCP configuration and a SDAP configuration upon successful paging of the UE. The routing management system is configured with a network interface to communicate with the user plane system to receive the downlink data notification based on the user plane session context.

[Clause 6] In an aspect, the network interface, of the clause 5, is configured to communicate using one of Packet Flow Classification Protocol (PFCP) or E1 Application Protocol (E1AP).

[Clause 7] In an aspect, the downlink data notification, of the clause 5, indicates transmitting data to the UE using one of low latency services, or low mobility services.

[Clause 8] In an aspect, the one or more forwarding rules, of the clause 5 indicate forwarding the downlink data to the RAN node using one of F1-U interface or User Datagram Protocol (UDP) tunnelling over Internet Protocol v6 (IPv6).

[Clause 9] In an aspect, the user plane control module, of the clause 1, is further configured to receive UE data from one of the session management module and the radio control module upon successful paging of the UE and send the UE data to the user plane system. The UE data comprises at least data associated with a RAN node, wherein the UE is in RRC_CONNECTED state with the RAN node.

[Clause 10] In an aspect, a user plane system is disclosed. The user plane system is configured to receive downlink data, addressed to a User Equipment (UE), from a data network. The UE is in one of a Radio Resource Control (RRC)_INACTIVE state and an RRC_IDLE state. The user plane system is configured to transmit a downlink data notification to a routing management system upon receiving the downlink data to initiate paging of the UE.

[Clause 11] In an aspect, the user plane system, of clause 10, is further configured with a network interface to communicate with the routing management system using one of Packet Flow Classification Protocol (PFCP) or E1 Application Protocol (E1AP).

[Clause 12] In an aspect, the user plane system, of clause 10, is configured to transmit the downlink data notification to initiate the paging by classifying downlink data as data addressed to the UE based on a user plane session context and generating the downlink data notification of the UE based on the user plane session context. The user plane session context is received from the routing management system for the PDU session of the UE, wherein the user plane session context comprising one or more packet detection rules and one or more forwarding rules. The one or more packet detection rules comprising at least one of receiving downlink data addressed to the UE and sending a downlink data notification to the routing management system. The one or more forwarding rules are associated with at least one of PDCP configuration and a SDAP configuration upon successful paging of the UE.

[Clause 13] In an aspect, the user plane system, of clause 10, is further configured to receive the UE data from the routing management system, wherein the UE data comprises at least a RAN node, wherein the UE is in RRC_CONNECTED state with the RAN node, and forward the downlink data to the UE, through the RAN node, based on the one or more forwarding rules.

[Clause 14] In an aspect, the one or more forwarding rules, of clause 13, indicate forwarding the downlink data to the RAN node using one of F1-U interface or User Datagram Protocol (UDP) tunnelling over Internet Protocol v6 (IPv6).

[Clause 15] In an aspect, an access management system is disclosed. The access management system is configured to receive a request from a User Equipment (UE) for registration, determine that the UE satisfies one or more predefined unification criteria and assign a session management module, communicatively coupled with a radio control module of a routing management system, to the UE based on the determination. The session management module is configured to assign a user plane system to the UE, wherein the user plane system is configured to receive downlink data, addressed to the UE from a data network and route the downlink data to a serving Radio Access Network (RAN) node serving the UE. The routing management system is further configured to receive a downlink data notification for the UE from the user plane system, wherein the UE is in one of a Radio Resource Control (RRC)_INACTIVE state or an RRC_IDLE state. The routing management system is configured to perform paging of the UE upon receiving the downlink data notification and identify UE data upon successful paging of the UE, wherein the UE data comprises at least data associated with a RAN node, wherein the UE is in RRC_CONNECTED state with the RAN node. The routing management system is configured to generate packet detection rules for the UE comprising forwarding rules associated with at least PDCP configuration and SDAP configuration without tunnelling rules and transmit the UE data and the packet detection rules to the user plane system for routing the downlink data.

[Clause 16] In an aspect, the one or more predefined unification criteria, of clause 15, comprises one of low latency services, and low mobility services.

[Clause 17] In an aspect, the processor, of clause 15, is further configured to determine an RRC state of the UE as RRC_IDLE state: and update the RRC state of the UE as RRC_INACTIVE state upon determining that the UE satisfies the one or more predefined unification criteria.

[Clause 18] In an aspect, a method performed by a routing management system is disclosed. The method comprising receiving a downlink data notification of a User Equipment (UE) from a user plane system and determining whether the User Equipment (UE) is in a Radio Resource Control (RRC)_INACTIVE state or an RRC_IDLE state in response to the downlink data notification. The method comprising performing one of initiating paging through a radio control module, of the routing management system, upon determining that the UE is in the RRC_INACTIVE state and initiating paging through a session management module, of the routing management system, upon determining that the UE is in the RRC_IDLE state. The method comprising establishing a communication between the UE and a Radio Access Network (RAN) node upon successful paging of the UE.

[Clause 19] In an aspect, the method, of clause 18, comprises determining whether the User Equipment (UE) is in a Radio Resource Control (RRC)_INACTIVE state or an RRC_IDLE state based on a core-level UE context information and a RAN-level UE context information.

[Clause 20] In an aspect, the method, of clause 18, comprises initiating the paging, by the session management module, by transmitting a paging initiation request to an access management system located in a core network.

[Clause 21] In an aspect, the method, of clause 18, comprises initiating the paging, by the radio control module, by transmitting a paging initiation request to a serving RAN node.

[Clause 22] In an aspect, the method, of clause 18, further comprises establishing a user plane session context in the user plane system, wherein the user plane session context comprising one or more packet detection rules and one or more forwarding rules. The packet detection rules comprising receiving downlink data from a data network addressed to the UE and sending a downlink data notification to the routing management system. The one or more forwarding rules associated with at least one of a PDCP configuration and an SDAP configuration upon successful paging of the UE.

[Clause 23] In an aspect, the method, of clause 22, comprises receiving the downlink data notification from the user plane system through a network interface that is configured to communicate using one of Packet Flow Classification Protocol (PFCP) or E1 Application Protocol (E1AP).

[Clause 24] In an aspect, the downlink data notification, of clause 22, indicates transmitting data to the UE using one of low latency services, or low mobility services.

[Clause 25] In an aspect, the method, of clause 18, further comprises receiving UE data from one of the session management module and the radio control module upon successful paging of the UE and sending the UE data to the user plane system. The UE data comprises at least data associated with a RAN node, wherein the UE is in RRC_CONNECTED state with the RAN node.

[Clause 26] In an aspect, the one or more forwarding rules, of clause 22, indicate forwarding the downlink data to the RAN node using one of F1-U interface or User Datagram Protocol (UDP) tunnelling over Internet Protocol v6 (IPv6).

[Clause 27] In an aspect, a method performed by a user plane system is disclosed. The method comprises receiving downlink data, addressed to a User Equipment (UE), from a data network. The UE is in one of a Radio Resource Control (RRC)_INACTIVE state and an RRC_IDLE state. The method comprising transmitting a downlink data notification to a routing management system upon receiving the downlink data to initiate paging of the UE.

[Clause 28] In an aspect, the method, of clause 27, further comprises transmitting the downlink data notification through a network interface that is configured to communicate using one of Packet Flow Classification Protocol (PFCP) or E1 Application Protocol (E1AP).

[Clause 29] In an aspect, the method, of clause 27, comprises transmitting the downlink data notification to initiate the paging by classifying downlink data as data addressed to the UE based on a user plane session context and generating the downlink data notification of the UE based on the user plane session context. The user plane session context is received from the routing management system for the PDU session of the UE, wherein the user plane session context comprising one or more packet detection rules and one or more forwarding rules. The one or more packet detection rules comprising at least one of receiving downlink data addressed to the UE and sending a downlink data notification to the routing management system. The one or more forwarding rules are associated with at least one of a PDCP configuration and an SDAP configuration upon successful paging of the UE.

[Clause 30] In an aspect, the method, of clause 27, further comprises receiving the UE data from the routing management system, wherein the UE data comprises at least a RAN node, wherein the UE is in RRC_CONNECTED state with the RAN node, and forward the downlink data to the UE, through the RAN node, based on the one or more forwarding rules.

[Clause 31] In an aspect, the one or more forwarding rules, of clause 29, indicate forwarding the downlink data to the RAN node using one of F1-U interface or User Datagram Protocol (UDP) tunnelling over Internet Protocol v6 (IPv6).

[Clause 32] In an aspect, a method performed by an access management system is disclosed. The method comprises receiving a request from a User Equipment (UE) for registration and determining that the UE satisfies one or more predefined unification criteria and assigning a session management module, communicatively coupled with a radio control module of a routing management system, to the UE based on the determination. The method performed by the session management module comprises assigning a user plane system to the UE, wherein the user plane system is configured to receive downlink data, addressed to the UE from a data network and route the downlink data to a serving Radio Access Network (RAN) node serving the UE. The method performed by the routing management system further comprises receiving a downlink data notification for the UE from the user plane system, wherein the UE is in one of a Radio Resource Control (RRC)_INACTIVE state or an RRC_IDLE state. The method performed by the routing management system comprises performing paging of the UE upon receiving the downlink data notification and identifying UE data upon successful paging of the UE, wherein the UE data comprises at least data associated with a RAN node, wherein the UE is in RRC_CONNECTED state with the RAN node. The method performed by the routing management system comprises generating one or more packet detection rules for the UE comprising one or more forwarding rules associated with at least PDCP configuration and SDAP configuration without tunnelling rules and transmitting the UE data and the one or more packet detection rules to the user plane system for routing the downlink data.

[Clause 33] In an aspect, the one or more predefined unification criteria, of clause 32, comprises one of low latency services, and low mobility services.

[Clause 34] In an aspect, the method, of clause 32, further comprises determining an RRC state of the UE as RRC_IDLE state: and updating the RRC state of the UE as RRC_INACTIVE state upon determining that the UE satisfies the one or more predefined unification criteria.

[Clause 35] In an aspect, a non-transitory computer-readable medium having program instructions stored thereon, executed by a routing management system is disclosed. The program instructions may comprise receiving a downlink data notification of a User Equipment (UE) from a user plane system. The program instructions may comprise determining whether the User Equipment (UE) is in a Radio Resource Control (RRC)_INACTIVE state or an RRC_IDLE state in response to the downlink data notification. The program instructions may comprise performing one of initiating paging through a radio control module, of the routing management system, upon determining that the UE is in the RRC_INACTIVE state and initiating paging through a session management module, of the routing management system, upon determining that the UE is in the RRC_IDLE state. The program instructions may comprise establishing a communication between the UE and a Radio Access Network (RAN) node upon successful paging of the UE.

[Clause 36] In an aspect, the program instructions of clause 35 may comprise determining whether the User Equipment (UE) is in a Radio Resource Control (RRC)_INACTIVE state or an RRC_IDLE state based on a core-level UE context information and a RAN-level UE context information.

[Clause 37] In an aspect, the program instructions of clause 35 may comprise initiating the paging, by the session management module, by transmitting a paging initiation request to an access management system located in a core network.

[Clause 38] In an aspect, the program instructions of clause 35 may comprise initiating the paging, by the radio control module, by transmitting a paging initiation request to a serving RAN node.

[Clause 39] In an aspect, the program instructions, of clause 35, may further comprise establishing a user plane session context in the user plane system, wherein the user plane session context comprising one or more packet detection rules and one or more forwarding rules. The packet detection rules comprising receiving downlink data from a data network addressed to the UE and sending a downlink data notification to the routing management system. The one or more forwarding rules associated with at least one of a PDCP configuration and an SDAP configuration upon successful paging of the UE.

[Clause 40] In an aspect, the program instructions, of clause 39, may comprise receiving the downlink data notification from the user plane system through a network interface that is configured to communicate using one of Packet Flow Classification Protocol (PFCP) or E1 Application Protocol (E1AP).

[Clause 41] In an aspect, the downlink data notification, of clause 35 or 39, indicates transmitting data to the UE using one of low latency services, or low mobility services.

[Clause 42] In an aspect, the program instructions, of clause 35, may further comprise receiving UE data from one of the session management module and the radio control module upon successful paging of the UE and sending the UE data to the user plane system. The UE data comprises at least data associated with a RAN node, wherein the UE is in RRC_CONNECTED state with the RAN node.

[Clause 43] In an aspect, the one or more forwarding rules, of clause 39, indicate forwarding the downlink data to the RAN node using one of F1-U interface or User Datagram Protocol (UDP) tunnelling over Internet Protocol v6 (IPv6).

[Clause 44] In an aspect, a non-transitory computer-readable medium having program instructions stored thereon, executed by a user plane system is disclosed. The program instructions may comprise receiving downlink data, addressed to a User Equipment (UE), from a data network. The UE is in one of a Radio Resource Control (RRC)_INACTIVE state and an RRC_IDLE state. The program instructions may comprise transmitting a downlink data notification to a routing management system upon receiving the downlink data to initiate paging of the UE.

[Clause 45] In an aspect, the program instructions, of clause 44, may further comprise transmitting the downlink data notification through a network interface that is configured to communicate using one of Packet Flow Classification Protocol (PFCP) or E1 Application Protocol (E1AP).

[Clause 46] In an aspect, the program instructions, of clause 44, may comprise transmitting the downlink data notification to initiate the paging by classifying downlink data as data addressed to the UE based on a user plane session context and generating the downlink data notification of the UE based on the user plane session context. The user plane session context is received from the routing management system for the PDU session of the UE, wherein the user plane session context comprising one or more packet detection rules and one or more forwarding rules. The one or more packet detection rules comprising at least one of receiving downlink data addressed to the UE and sending a downlink data notification to the routing management system. The one or more forwarding rules are associated with at least one of a PDCP configuration and an SDAP configuration upon successful paging of the UE.

[Clause 47] In an aspect, the program instructions, of clause 44, may further comprise receiving the UE data from the routing management system, wherein the UE data comprises at least a RAN node, wherein the UE is in RRC_CONNECTED state with the RAN node, and forward the downlink data to the UE, through the RAN node, based on the one or more forwarding rules.

[Clause 48] In an aspect, the one or more forwarding rules, of the clause 44, indicate forwarding the downlink data to the RAN node using one of F1-U interface or User Datagram Protocol (UDP) tunnelling over Internet Protocol v6 (IPv6).

[Clause 49] In an aspect, a non-transitory computer-readable medium having program instructions stored thereon, executed by an access management system is disclosed. The program instructions may comprise receiving a request from a User Equipment (UE) for registration and determining that the UE satisfies one or more predefined unification criteria. The program instructions may comprise assigning a session management module, communicatively coupled with a radio control module of a routing management system, to the UE based on the determination. Program instructions for the session management module may comprise assigning a user plane system to the UE, wherein the program instructions for the user plane system may comprise receiving downlink data, addressed to the UE from a data network and routing the downlink data to a serving Radio Access Network (RAN) node serving the UE. The program instructions of the routing management system may further comprise receiving a downlink data notification for the UE from the user plane system, wherein the UE is in one of a Radio Resource Control (RRC)_INACTIVE state or an RRC_IDLE state. The program instructions of the routing management system further comprise performing paging of the UE upon receiving the downlink data notification and identifying UE data upon successful paging of the UE, wherein the UE data comprises at least data associated with a RAN node, wherein the UE is in RRC_CONNECTED state with the RAN node. The program instructions of the routing management system comprise generating one or more packet detection rules for the UE comprising one or more forwarding rules associated with at least PDCP configuration and SDAP configuration without tunnelling rules and transmitting the UE data and the one or more packet detection rules to the user plane system for routing the downlink data.

[Clause 50] In an aspect, the one or more predefined unification criteria, of the clause 49, comprises one of low latency services, and low mobility services.

[Clause 51] In an aspect, the program instructions, of the clause 49, further comprise determining an RRC state of the UE as RRC_IDLE state: and updating the RRC state of the UE as RRC_INACTIVE state upon determining that the UE satisfies the one or more predefined unification criteria.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternatives (including equivalents, extensions, variations, deviations, etc., of those described herein) will be apparent to persons skilled in the relevant art(s) based on the teachings contained herein. Such alternatives fall within the scope of the disclosed embodiments.

Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Finally, the language used in the specification has been principally selected for readability and instructional purposes, and it may not have been selected to delineate or circumscribe the inventive subject matter. Accordingly, the disclosure of the embodiments of the disclosure is intended to be illustrative, but not limiting, of the scope of the disclosure. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

We claim:

1. A routing management system comprising:
a user plane control module:
a session management module communicatively coupled with the user plane control module: and a radio control module communicatively coupled with the user plane control module:
wherein the user plane control module is configured to:
receive a downlink data notification of a User Equipment (UE) from a user plane system:
determine whether the UE is in a Radio Resource Control (RRC)_INACTIVE state or an RRC_IDLE state in response to the downlink data notification:
perform one of:
initiating paging through the radio control module upon determining that the UE is in the RRC_INACTIVE state; and
initiating paging through the session management module upon determining that the UE is in the RRC_IDLE state: and
establish a communication between the UE and a Radio Access Network (RAN) node upon successful paging of the UE.

2. The routing management system of claim 1, wherein the user plane control module is configured to determine whether the User Equipment (UE) is in the RRC_INACTIVE state or the RRC_IDLE state based on a core-level UE context information and a RAN-level UE context information.

3. The routing management system of claim 1, wherein the session management module is configured to initiate the paging by transmitting a paging initiation request to an access management system located in a core network.

4. The routing management system of claim 1, wherein the radio control module is configured to initiate the paging by transmitting a paging initiation request to a serving RAN node.

5. The routing management system of claim 1, wherein the user plane control module is further configured to:
establish a user plane session context in the user plane system, wherein the user plane session context comprising one or more packet detection rules and one or more forwarding rules,
wherein the one or more packet detection rules comprising:
receiving downlink data from a data network addressed to the UE; and
sending a downlink data notification to the routing management system: and
wherein the one or more forwarding rules are associated with at least one of a packet data convergence protocol and a service data application protocol upon successful paging of the UE: and
wherein the routing management system is configured with a network interface to communicate with the user plane system to receive the downlink data notification based on the user plane session context.

6. The routing management system of claim 5, wherein the network interface is configured to communicate using one of Packet Flow Classification Protocol (PFCP) or E1 Application Protocol (E1AP).

7. The routing management system of claim 5, wherein the downlink data notification indicates transmitting data to the UE using one of low latency services, or low mobility services.

8. The routing management system of claim 5, wherein the one or more forwarding rules indicate forwarding the downlink data to the RAN node using one of:
F1-U interface or User Datagram Protocol (UDP) tunnelling over Internet Protocol v6 (IPv6).

9. The routing management system of claim 1, wherein the user plane control module is further configured to:
receive UE data from one of the session management module and the radio control module upon successful paging of the UE, wherein the UE data comprises at least data associated with the RAN node, wherein the UE is in RRC_CONNECTED state with the RAN node: and
transmit the UE data to the user plane system.

10. A user plane system configured to:
receive downlink data, addressed to a User Equipment (UE), from a data network, wherein the UE is in one of a Radio Resource Control (RRC)_INACTIVE state and an RRC_IDLE state: and
transmit a downlink data notification to a routing management system upon receiving the downlink data to initiate paging of the UE.

11. The user plane system of claim 10, wherein the user plane system is further configured with a network interface to communicate with the routing management system using one of Packet Flow Classification Protocol (PFCP) or E1 Application Protocol (E1AP).

12. The user plane system of claim 10, wherein to transmit the downlink data notification to initiate the paging, the user plane system is configured to:
classify downlink data as data addressed to the UE based on a user plane session context:
generate the downlink data notification of the UE based on the user plane session context, wherein the user plane session context is received from the routing management system for a PDU session of the UE, wherein the user plane session context comprising one or more packet detection rules and one or more forwarding rules, and
wherein the one or more packet detection rules comprising at least one of:
receiving downlink data addressed to the UE; and
sending a downlink data notification to the routing management system, and
wherein the one or more forwarding rules associated with at least one of packet data convergence protocol and a service data application protocol upon successful paging of the UE.

13. The user plane system of claim 10, wherein the user plane system is further configured to:
receive the UE data from the routing management system, wherein the UE data comprises at least data associated with a RAN node, wherein the UE is in an RRC_CONNECTED state with the RAN node; and
forward the downlink data to the UE, through the RAN node, based on one or more forwarding rules.

14. The user plane system of claim 13, wherein the one or more forwarding rules indicate forwarding the downlink data to the RAN node using one of:
F1-U interface or User Datagram Protocol (UDP) tunnelling over Internet Protocol v6 (IPv6).

15. An access management system configured to:
receive a request from a User Equipment (UE) for registration;
determine that the UE satisfies one or more predefined unification criteria;
assign a session management module, communicatively coupled with a radio control module of a routing management system, to the UE based on the determination, wherein the session management module is configured to assign a user plane system to the UE, wherein the user plane system is configured to:
receive downlink data, addressed to the UE from a data network; and
route the downlink data to a serving Radio Access Network (RAN) node serving the UE;
wherein the routing management system is further configured to:
receive a downlink data notification for the UE from the user plane system, wherein the UE is in one of a Radio Resource Control (RRC)_INACTIVE state or an RRC_IDLE state; and
perform paging of the UE upon receiving the downlink data notification;
receive UE data upon successful paging of the UE, wherein the UE data comprises at least data associated with a RAN node, wherein the UE is in RRC_CONNECTED state with the RAN node;
generate packet detection rules for the UE comprising one or more forwarding rules associated with at least packet data convergence protocol and service data application protocol without tunnelling rules upon successful paging of the UE; and
transmit the UE data and the packet detection rules to the user plane system for routing the downlink data.

16. The access management system of claim 15, wherein the one or more predefined unification criteria comprises one of low latency services, and low mobility services.

17. The access management system of claim 15, wherein upon determining that the UE satisfies the one or more predefined unification criteria, the access management system is further configured to:
determine an RRC state of the UE as RRC_IDLE state; and
update the RRC state of the UE from RRC_IDLE state to RRC_INACTIVE state.
